(19) United States
(12) Patent Application Publication
(10) Pub. No.: US 2006/0145121 A1
(43) Pub. Date: Jul. 6, 2006

(54) Retardation of crystallization in oligomeric phosphate compositions

(75) Inventors: Sergei Levchik, Croton-on-Hudson, NY (US); Gerald R. Alessio, Emerson, NJ (US)

Correspondence Address: DILWORTH & BARRESE, LLP, 333 EARLE OVINGTON BLVD., UNIONDALE, NY, 11553, US

(73) Assignee: Supresta LLC, Ardsley, NY (US)

(21) Appl. No.: 10/532,751

(22) PCT Filed: Oct. 25, 2003
(86) PCT No.: PCT/US03/34038

§ 371 Date: Nov. 28, 2005

Related U.S. Application Data
(60) Provisional application No. 60/421,520, filed on Oct. 26, 2002.

(51) Int. Cl. C09K 3/00

(52) U.S. Cl. 252/182.3

(57) ABSTRACT

Storing, for a period of time, of a blend comprising an arylene-bridged oligomeric phosphate composition and an effective amount of an alkylene-bridged bisphosphate results in a retardation of crystallization as compared to storage of a composition comprising the arylene-bridged oligomeric phosphate composition without also containing the alkylenebridged bisphosphate.

### FIELD OF THE INVENTION

This invention relates to the retardation of crystallization of a composition containing an arylene-bridged oligomeric phosphate flame retardant. Such a composition can be used as a flame retardant additive, for example, in engineering resins.

### BACKGROUND OF THE INVENTION

Arylene-bridged oligomeric phosphate compositions, such as bisphenol A bis(diphenyl phosphate), have the tendency, when stored, to crystallize as described at Col. 2, lines 1-5 of U.S. Pat. No. 6,319,432 to W. B. Harrod et al. It is known to use such oligomeric phosphate esters as flame retardants in engineering resins, such as polycarbonate-containing polymer compositions. It is also known to employ blends of alkylene-bridged compositions and arylene-bridged compositions (see, for example, PCT Patent Publication No. WO 96/11977, which does not show or suggest the retardation of the crystallization of arylene-bridged oligomeric phosphate compositions by adding to such a composition an alkylene-bridged oligomeric phosphate, as will be further described below).

### DESCRIPTION OF THE INVENTION

The present invention relates to the retardation of crystallization that would normally take place over time for such arylene-bridged oligomeric phosphate compositions by adding a sufficient amount of an alkylene-bridged oligomeric phosphate to such an arylene-bridged oligomeric phosphate composition to effect such retardation of crystallization.

The arylene-bridged oligomeric phosphate compositions that can be improved in regard to their crystallization behavior are of the following formula: 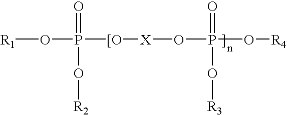
where R¹, R², R³, R⁴ are each aryl or substituted aryl, X is a bridging group derived from a diol that comprises an arylene moiety, and n preferably ranges from about 1 to about 5. The grouping —O—X—O— in the above-depicted formula can be derived from such diols as hydroquinone, resorcinol, and bisphenol A.

The foregoing type of phosphate compositions can have their crystallization retarded, upon being stored, by the incorporation therein of an effective amount (from about 10% to about 80%, by weight) of the arylene-bridged oligomeric phosphate composition of the formula 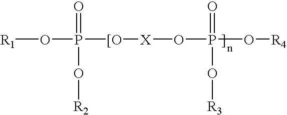
where R¹, R², R³, R⁴ are each aryl or substituted aryl, X is a bridging group derived from a diol that comprises an alkylene moiety, and n preferably is 1. The grouping —O—X—O— in the above-depicted formula can be derived from a diol such as neopentyl glycol.

This effect for the alkylene-bridged bisphosphate is unexpected despite the fact that mixtures of it and arylene-bridged oligomeric phosphate compositions have been described before in PCT WO 96/11996 for improvement of the viscosity of oligomeric phosphate ester flame retardants. This PCT patent application does not discuss the effect that the alkylene-bridged bisphosphate has when the blend of it and the arylene-bridged oligomeric phosphate composition is stored for a period of time that would normally cause crystallization, for example, in a neat arylene-bridged oligomeric phosphate composition.

As indicated above, a preferred alkylene-bridged bisphosphate for use herein is neopentylglycol bis(diphenyl phosphate) of the following formula: 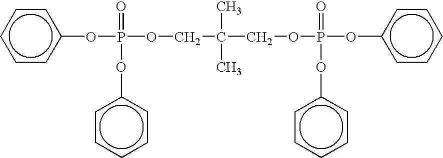
This product is most preferably a liquid product containing more than 80 wt. % of the bisphosphate depicted immediately above, less than 5 wt. % of the cyclic product 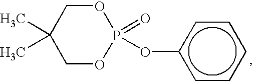
and less than 8 wt. % of triphenyl phosphate.

The present invention is further illustrated by the Examples that follow.

### EXAMPLES 1-6

Bisphenol A bis(diphenyl phosphate), “BDP”, and neopentylglycol bis(diphenyl phosphate), “NDP”, were mixed at different ratios as shown in Table 1. The viscosities of plain aromatic bisphosphates and their blends were measured at 55° C. and 70° C. using a Brookfield viscometer. The mixtures of BDP/NDP were poured in the 50 ml test tubes, caped and placed in the laboratory freezer at −15° C. Plain BDP and plain NDP (Examples 1 and 2, which are presented for comparative purposes, were treated in the similar way as the BDP/NDP mixtures. The results of viscosity measurements as well as freezing measurements are shown in Table 1:

TABLE 1

| | Aromatic | Viscosity, centipoise | | Time to freeze |
|---|---|---|---|---|
| # | bisphosphate | 55° C. | 70° C. | day |
| 1 | BDP | 420 | 181 | 1 day |
| 2 | NDP | 50 | 26 | >300 |
| 3 | BDP/NDP = 4:1 | 229 | 97 | >300 |
| 4 | BDP/NDP = 3:2 | 178 | 71 | >300 |
| 5 | BDP/NDP = 2:3 | 98 | 47 | >300 |
| 6 | BDP/NDP = 1:4 | 71 | 36 | >300 |

BDP: Bisphenol A bis(diphenyl phosphate)
NDP: Neopentylglycol bis(diphenyl phosphate)

NDP also helps significantly decrease viscosity of BDP which is beneficial for handling of aromatic bisphosphates, particularly for pumping aromatic bisphosphates into extruder during compounding.

BDP/NDP mixtures do not freeze at prolonged storage at low temperatures therefore these mixtures do not require heated tank for their storage and heat-traced lines for their transfer.

The foregoing Examples should not be construed in a limiting sense since they are being presented only to illustrate certain embodiments of the present invention. The scope of protection is set forth in the claims that follow.

1. A method comprising the storing, for a period of time, of a blend comprising an arylene-bridged oligomeric phosphate composition and an effective amount of an alkylene-bridged bisphosphate for retardation of the time within which crystallization occurs as compared to a composition comprising the arylene-bridged oligmeric phosphate composition that does not also contain the alkylene-bridged bisphosphate.

2. A method as claimed in claim 1 wherein the arylene-bridged oligmeric phosphate composition contains a bridging group derived from bisphenol A.

3. A method as claimed in claim 1 wherein the arylene-bridged bisphosphate contains a bridging group derived from neopentyl glycol.

4. A method of claimed in claim 1 wherein the arlene-bridged oligomeric bisphosphate contains a bridging group derived from bisphenol A and the alkylene-bridged bisphosphate contains a bridging group derived from neopentyl glycol.

5. A method as claimed in claim 1 wherein the alkylene-bridged bisphosphate is present in'the blend at from about 100% to about 80%, by weight of the arylene-bridged oligmeric phosphate composition.

6. A method as claimed in claim 2 wherein the alkylene-bridged bisphosphate is present in the blend at from about 10% to about 80%, by weight of the arylene-bridged oligmeric phosphate composition.

7. A method as claimed in claim 3 wherein the alkylene-bridged bisphosphate is present in the blend at from about 10% to about 80%, by weight of the arylene-bridged oligmeric phosphate composition.

8. A method as claimed in claim 4 wherein the alkylene-bridged bisphosphate is present in the blend at from about 10% to about 80%, by weight of the arylene-bridged oligmeric phosphate composition.
